(19) United States
(12) Patent Application Publication
(10) Pub. No.: US 2014/0089174 A1
(43) Pub. Date: Mar. 27, 2014

(54) APPLICATION HOSTING WITHIN A SECURED FRAMEWORK IN A FUELING ENVIRONMENT

(71) Applicants: Gilbarco, S.r.l., Firenze (IT); Gilbarco Inc., Greensboro, NC (US)

(72) Inventors: Giovanni CARAPELLI, High Point, NC (US); Rodger K. WILLIAMS, Siler City, NC (US); Frederick Donald RICHEY, Kernersville, NC (US); Thomas J. PARK, Greensboro, NC (US); Deron Wayne FREEZE, Gold Hill, NC (US); Ivan Rubin AYMA, Greensboro, NC (US)

(73) Assignees: Gilbarco, S.r.l., Firenze (IT); Gilbarco Inc., Greensboro, NC (US)

(21) Appl. No.: 14/032,608

(22) Filed: Sep. 20, 2013

Related U.S. Application Data
(60) Provisional application No. 61/704,158, filed on Sep. 21, 2012.

(51) Int. Cl. G06Q 20/38

(52) U.S. Cl. CPC G06Q 20/38
USPC 705/39

(57) ABSTRACT

A secured framework for hosting secure and non-secure applications is provided. A master control apparatus includes an interface component for providing input to or output from the master control apparatus, and an interface communicating component for establishing a communications path to a portion of the interface component when a secured portion of the interface component is active. The interface communicating component provides data from a feature apparatus to the portion of the interface component over the communications path, and switches the communications path to refrain from providing data from the feature apparatus where the secured portion of the interface component is active. A security analyzing component can also be included to additionally or alternatively determine whether access is allowed to the portion of the interface component.

### CROSS-REFERENCE TO RELATED APPLICATIONS

The present application claims the benefit of U.S. patent application No. 61/704,158, filed Sep. 21, 2012, and entitled “APPLICATION HOSTING WITHIN A SECURED FRAMEWORK,” the disclosure of which is hereby incorporated by reference as if set forth verbatim herein in its entirety and relied upon for all purposes.

### TECHNICAL FIELD

The subject matter described herein relates generally to application hosting, and more particularly, to managing security of feature applications in a secured framework of a fueling environment.

### BACKGROUND

Retail fueling dispensers offer inputs for customer data in routine and specific manners, such as answering of scripted yes/no questions, credit card swiping, zip code entry, etc. While this facilitates control over reception and further communication of the customer data, the dispensers are unable to utilize different business applications or services desired by retail merchants for possibly increasing revenue, loyalty, and a unique user experience. Introduction of such applications or services at the fuel dispensers may compromise security of customer data by allowing the applications or services to access the same inputs currently utilized at the dispensers.

One particular concern is that fuel dispensers are limited and unable to offer integrated payment solutions in a dynamic and secure manner. Typically, a dispenser obtains payment information and relays the information to an electronic payment system (EPS), which can provide security when communicating with appropriate financial institutions. Allowing an application or service to access the inputs at the dispenser, however, may create a security risk such that the application, or a rogue entity using the application, may be able to obtain confidential information.

Various aspects of controlling secure and non-secure content on fuel dispensers or retail devices and enhanced dispenser hubs are disclosed in US Patent Publication No. 2009/0265638 and US Patent Publication No. 2012/0046787, both of which are incorporated herein by reference for all purposes.

### SUMMARY

The following presents a simplified summary of one or more aspects to provide a basic understanding thereof. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that follows.

Aspects described herein are directed to hosting applications in a secured framework. The framework can include multiple hardware configurations where at least one of the configurations is a master control configuration that controls all input and/or output at an interface. In this regard, the master control configuration can manage security for at least a portion of the input and/or output at the interface. The master control configuration, for example, can implement varying levels of security for input and/or output at a given application, acting as a gateway and firewall for the interface. The levels of security can relate to various inputs and/or outputs at the interface, offering a granular specification of access for a given application. In additional examples, the master control configuration can modify input from or output to the interface at the application level (rather than allowing passage of raw data) to provide another level of security for the data.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations may denote like elements, and in which:

FIG. 1 is an aspect of an example system for hosting applications in a secure framework.

FIG. 2 is an aspect of an example system for determining whether to authorize access of interface components to non-secure applications.

FIG. 3 is an aspect of an example system for hosting applications at a universal payment module (UPM).

FIG. 4 is an aspect of an example service oriented architecture in accordance with aspects described herein.

FIG. 5 is an aspect of an example fuel dispensing environment in accordance with aspects described herein.

FIG. 6 is an aspect of an example fuel dispensing environment with various services executing on a feature processor.

FIG. 7 is an aspect of an example system for hosting applications at a fuel dispenser.

FIG. 8 is an aspect of an example methodology for switching a communications path to support secure and non-secure applications.

FIG. 9 is an aspect of an example methodology for determining whether to allow application access to a portion of an interface.

FIG. 10 is an aspect of an example system in accordance with aspects described herein.

FIG. 11 is an aspect of an example communication environment in accordance with aspects described herein.

### DETAILED DESCRIPTION

Reference will now be made in detail to various aspects, one or more examples of which are illustrated in the accompanying drawings. Each example is provided by way of explanation, and not limitation of the aspects. In fact, it will be apparent to those skilled in the art that modifications and variations can be made in the described aspects without departing from the scope or spirit thereof. For instance, features illustrated or described as part of one example may be used on another example to yield a still further example. Thus, it is intended that the described aspects cover such modifications and variations as come within the scope of the appended claims and their equivalents.

Described herein are various aspects relating to hosting secure and non-secure applications in a secured framework. The framework includes at least one control master configuration, which is a hardware configuration on which secure applications may execute. The control master configuration manages access of non-secure applications executing on other hardware configurations to one or more interfaces provided in the framework, or at least to certain aspects of input and/or output related to the one or more interfaces. The control master configuration can provide varying levels of access for various non-secure applications to the interface, can modify data communicated between the interface and one or more non-secure applications, etc., based on a type of the non-secured application, whether the non-secured application is from a trusted source, etc.

In a specific example, the framework can exist in a fuel dispenser where the master control configuration can include an in-dispenser payment system, such as a universal payment module (UPM), and other hardware configurations can include one or more feature processors that can execute non-secured applications. In this example, the in-dispenser payment system operates an interface on the fuel dispenser, which can include a display, a card reader, a number pad, etc., to process payment of fuel. The in-dispenser payment system can allow feature processors to access the display, while preventing or limiting access to the card reader, number pad, etc. In this example, other parties can feed video to the display through applications executing on the feature processor without being able to access communications with other parts of the interface at the fuel dispenser, thus mitigating security risks described above.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Artificial intelligence based systems (e.g., explicitly and/or implicitly trained classifiers) can be employed in connection with performing inference and/or probabilistic determinations and/or statistical-based determinations in accordance with one or more aspects of the subject matter as described hereinafter. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for generating higher-level events from a set of events and/or data. Such inference results in the construction of new events or actions from a set of observed events or stored event data, regardless of whether the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines, etc.), for example, can be employed in connection with performing automatic and/or inferred actions in connection with the subject matter.

Furthermore, the subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it is to be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the subject matter.

Moreover, the term or is intended to mean an inclusive or rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and an as used in this application and the appended claims should generally be construed to mean one or more unless specified otherwise or clear from the context to be directed to a singular form.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

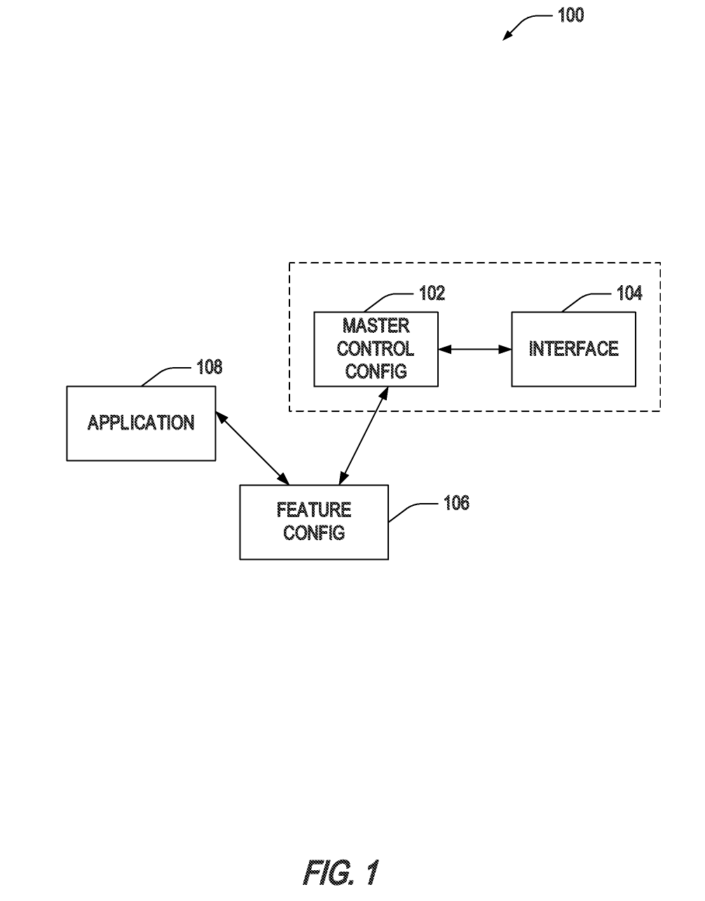

FIG. 1 illustrates an example system 100 for hosting applications in a secured framework. System 100 includes a master control configuration 102 (or master control apparatus) that provides communication with one or more components of an interface 104. The master control configuration 102 can include one or more hardware configuration components, such as a processor, an associated memory, one or more modules that include a processor, memory, etc., such as a system on module (SoM), UPM or other in-dispenser payment module, and/or the like. Interface 104 can include one or more of a display, which can be a touch-screen display, a printer (e.g., a receipt printer), a card reader, a number pad, a bar code scanner, a radio frequency identifier (RFID) reader or transmitter, a near field communication (NFC) reader or transmitter, a Bluetooth transceiver, a WiFi transceiver, or substantially any input and/or output device(s). System 100 also includes a feature configuration 106 (or feature apparatus), which can be a hardware configuration similar to or different from hardware included in master control configuration 102, that executes one or more applications 108.

Master control configuration 102 and interface 104 may be part of a secured framework. In this example, master control configuration 102 can execute secure applications that can have full access, or at least more access than non-secure applications, to at least some components of interface 104. In one example, interface 104 can be part of or provided by master control configuration 102. For example, interface 104 can include a card reader input device, and master control configuration 102 can execute payment software (e.g., an electronic payment system (EPS)) that uses card reader input to process transaction payment by communicating card information to financial institutions or other systems (not shown). For example, the secure applications can include legacy applications performed by a fuel dispenser to dispense fuel, process payment thereof, monitor fuel tank status, monitor valve status, etc.

Master control configuration 102 can also allow non-secure applications some access of interface 104. In this example, feature configuration 106 can execute one or more non-secure applications 108 that utilize one or more parts of interface 104, such as a display to render pictorial or video content (e.g., where the display is used by legacy applications at the master control configuration 102 to prompt whether a car wash is desired, whether a receipt is desired, etc.). In this example, feature configuration 106 can request access to a desired portion of interface 104 from master control configuration 102, and the master control configuration 102 can grant access. In this example, master control configuration 102 can act as a gateway and firewall for interface 104, protecting other portions thereof from the non-secure applications.

Master control configuration 102 can provide varying levels of security for different non-secure applications, and/or can modify information provided to or received form interface 104 on an application level. In another example, it is to be appreciated that master control configuration 102 can provide all applications from feature configuration 106 with a limited access regardless of the application. In one example, master control configuration 102 can implement a video switch to allow the feature configuration 106 output access to a display of interface 104 while denying (e.g., through hardwiring or packet filtering) access to other parts of the interface 104. Moreover, the master control configuration 102 can switch the video switch when it is utilizing the interface 104 to prevent any possible access by feature configuration 106. This can result in secure communications between master control configuration 102 and its interface 104.

In one specific example, the master control configuration 102 can include a UPM of a fuel dispenser, and the interface 104 can include a display and a card reader, which can be part of the UPM as well. In this example, master control configuration 102 executes applications related to the UPM that can receive data from the card reader (e.g., for transaction payment). In this example, master control configuration 102 can communicate card information with one or more financial institutions to authorize payment for a transaction based on the card information. During this time, master control configurations 102 can terminate any communication path from feature configuration 106 to interface 104 to prevent interception of confidential information. This can include switching a video switch, as described, disabling a connector that allows feature configuration to communicate with interface 104 through master control configuration 102, and/or the like.

In any case, the master control configuration 102 can protect the card reader by not allowing access thereof to applications 108 executing on feature configuration 106. Master control configuration 102 can, however, grant access to a display and/or audio of interface 104 such that the applications 108 can use the display and/or audio to render advertisements. In other examples, applications 108 executing on feature configuration 106 can be associated with or otherwise received from one or more application sources. The sources can be trusted or non-trusted, in one example. Thus, for example, master control configuration 102 can provide trusted non-secure applications with access to the card reader, but not non-trusted applications.

Moreover, master control configuration 102 can modify raw data before passing the data between a portion of interface 104 and an application 108. The modification can be based on an application, application type, application source, etc., as well. For example, master control configuration 102 can allow a mid-level security application 108 to request encrypted data from interface 104 (e.g., blocked personal identification number (PIN) data where the interface 104 can receive and encrypt the data), but allow high-level security application 108 to request un-encrypted (raw) data entry from interface 104 (e.g., unblocked PIN data) for use in the application 108. Similarly, master control configuration 102 can modify data rendered on a display of interface 104 based on the application 108, a type thereof, a source thereof, etc.

It is to be appreciated that the master control configuration 102 and feature configuration 104 can operate on a single secure architecture, such that one exists but not the other, and this architecture can operate in the secure environment with interface 104, in one example. For example, the feature configuration 106 can provide a web browser (e.g., a hypertext markup language (HTML) 5 browser or similar technology) that can execute the non-secure applications 108, and/or other secure applications (e.g., for payment) and can be part of the secured environment with the interface 104. In this example, the master control configuration 102 may not be present. Also, in this example, the feature configuration 106 can control access of the web browser or associated components to the interface 104. Further, in this example, the feature control configuration 106 can control access of various applications 108, as described herein, at various levels (e.g., per application, per application type, per application source, etc.). Moreover, in this example, the functionality can be implemented as software within the feature control configuration 106 to determine which applications 108 operating on the feature control configuration 106 are secure or non-secure, and/or have or do not have access to various portions of interface 104.

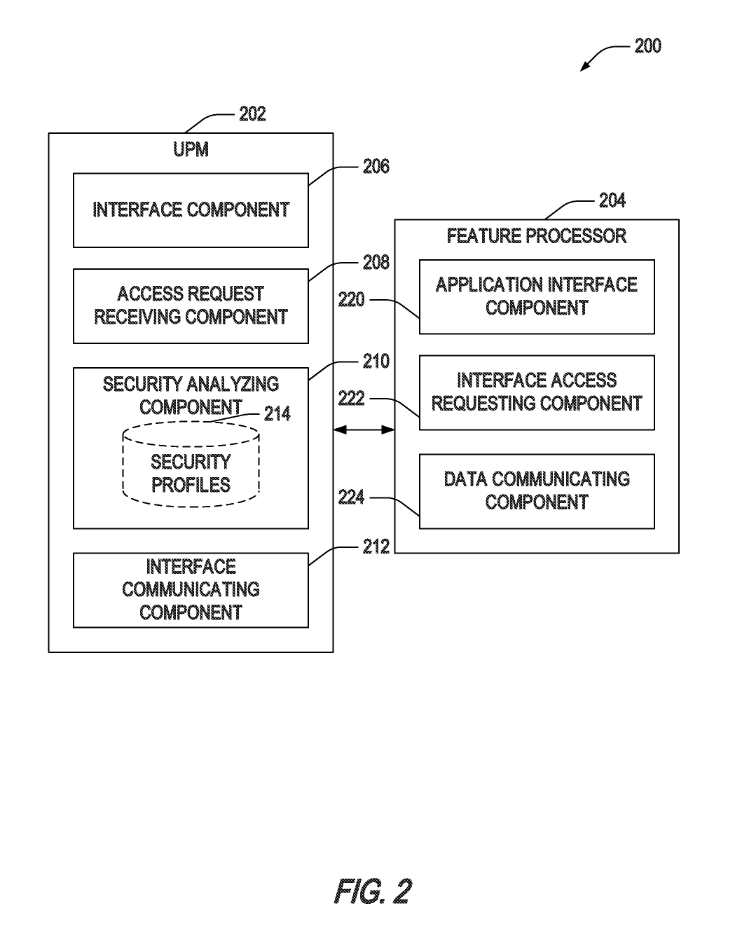

FIG. 2 illustrates an example system 200 for hosting secure and non-secure applications at a fuel dispenser or other vending machine. System 200 includes a UPM 202 for processing transactions via various interface components, and a feature processor 204 for executing applications that can utilize at least some of the interface components of the UPM 202. The UPM 202 and feature processor 204 can be present in a fuel dispenser or other vending machine that includes mechanisms for automatically facilitating and processing purchase transactions.

UPM 202 includes an interface component 206 that can include one or more input and/or output devices, such as a display (e.g., a touch-screen display), a card reader, a number pad, etc., as described above with respect to interface 104. UPM 202 also includes an access request receiving component 208 for obtaining a request to access one or more input and/or output devices of interface component 206, or portions thereof, a security analyzing component 210 for determining whether the request is authorized, and an interface communicating component 212 for communicating data to/from interface component 206. Security analyzing component 210 can include one or more security profiles 214 stored in a database or other data store that can be leveraged to determine authorization for a request.

Feature processor 204 includes an application interface component 220 to allow one or more applications to utilize or otherwise execute upon the feature processor 204, an interface access requesting component 222 for requesting access to an interface of a UPM, and a data communicating component 224 for communicating data to/from the interface of the UPM. It is to be appreciated, for example, that the feature processor 204 can include components of the UPM 202 functioning as described herein (e.g., when operating as an independent processor or as software without the UPM 202 to provide security) to provide interface component 206 access to the applications. In one specific example, the feature processor 204 can provide a web browser to the interface component 206 allowing interaction therewith via a display, keyboard, etc. In this example, feature processor 204 can manage access of the web browser or related components to the interface component 206 for applications executing thereon, as described below with respect to UPM 202.

According to an example, UPM 202 can operate various input and/or output devices of interface component 206 in executing secure applications related to the fuel dispenser or vending machine. For example, such secure applications can include payment processing applications, applications to purchase items from a related store (e.g., a car wash), or substantially any application that is executed by UPM 202. In one example, UPM 202 has full access to the input/output devices of interface component 206 for such applications. In addition, however, UPM 202 can act as a gateway and firewall to the devices of interface component 206, providing selective access thereto for other applications that execute on other hardware configurations.

In this example, application interface component 220 can execute an application or otherwise provide an interface utilized by an application that may request access to one or more components of an interface of UPM 202. Interface access requesting component 222 can accordingly attempt to obtain access to the interface from UPM 202 by communicating at least a portion of the request thereto. Access request receiving component 208 obtains the request, and, in one example, engages security analyzing component 210 to determine whether to authorize the request for access to the interface. Security profiles 214 can include a plurality of profiles, which can be generic profiles for all applications, profiles for each application or a group of types of applications, profiles for trusted and non-trusted applications, profiles for sources of applications, etc., and can include parameters regarding portions of interface component 206, or devices thereof, to which the profiles have access. For example, this can also include a type of access (e.g., read, read/write, etc.).

Thus, security analyzing component 210 can query the security profiles 214 based on one or more aspects of the request (e.g., an identifier of the application, a type of the application, a source of the application, etc., the portion of interface component 206 for which access is requested, and/or the like), in an attempt to acquire a related security profile for determining whether to allow the access. In one example, security analyzing component 210 can additionally or alternatively infer whether to grant access based on one or more parameters of the application, security profile, etc. For example, where the application does not have a stored security profile, security analyzing component 210 can determine profile of similar applications (e.g., application from a similar source or of a similar type), and can infer whether to grant access based on profiles of similar applications.

Where security analyzing component 210 determines to authorize the access request, access request receiving component 208 can communicate the authorization to feature processor 204 for providing to the application. Interface access requesting component 222 can receive the authorization and can notify the application via application interface component 220. Data communicating component 224 can subsequently communicate data from the application with UPM 202 for providing to and/or receiving from the interface component 206. Interface communicating component 212 can allow data from feature processor 204 to reach appropriate device or portion thereof of interface component 206, and/or can facilitate communicating data from interface component 206 to the application via feature processor 204. For example, this can include interface communicating component 212 switching a communications path to the interface component 206 to allow control by the feature processor 204, enabling a feature connector that couples the feature processor 204 to the UPM 202, etc., as described.

In one example, such a communications path to the interface component 206 can be switchable between the UPM 202 (or one or more related components) and the feature processor 204, or a collection of processors. In one example, interface communicating component 212 can switch the communications path to the feature processor 204 not only based on the security analyzing component 210 determination, but additionally or alternatively when a portion of the interface component 206 to which the application does not have access (referred to herein as a secured portion) is not active. This can be the default switch position. Upon activation of a secured portion of the interface component 206 (e.g., a number pad, a touch screen requesting a PIN, etc.), however, interface communicating component 212 can switch the communications path to the UPM 202 or related internal components to close any external path to the secured portion of the interface component 206. In one example, this includes terminating the feature connector described above. It is to be appreciated that interface communicating component can detect the activation of the secured portion, and can determine, in this case, that the application is not allowed to access the portion based on the one or more security profiles.

Similarly, interface communicating component 212 can switch the communications path back to feature processor 204 upon detecting that the secured portion of interface component 206 is deactivated. In both cases, in this example, data passes through UPM 202 based on the switch, though it is to be appreciated that in other examples the interface communicating component 212 can route or drop packets based on the activation of the portion of the interface component 206 and whether or not the application has access based on the one or more security profiles. The interface component 206 can additionally or alternatively establish/terminate a secure tunnel directly between interface component 206 and feature processor 204 for the requested access.

In another example, interface communicating component 212 can modify the data provided to or received from portions of the interface component 206 for which access is granted to the application pursuant to the related security policy. For example, as described, interface communicating component 212 may block or otherwise encrypt number pad entries on interface component 206 when providing information back to feature processor 204 for a related application. Thus, the application can decrypt the number pad entries upon receipt, which can prevent acquisition of the entries during transfer from UPM 202 to feature processor 204.

Where security analyzing component 210 determines not to authorize the access request, access request receiving component 208 can communicate an error or other indication of the non-authorization to feature processor 204 for providing to the application. Interface access requesting component 222 can receive the indication and can notify the application via application interface component 220.

In a specific example, UPM 202 can execute applications for payment processing via interface component 206, as described, but can restrict access for applications running on feature processor 204 (e.g., requests from applications coming from interface access requesting component 222) to enable an output portion of a touch screen display of interface component 206. In this example, security profiles 214 can include a profile restricting all applications, certain applications, applications of a certain type, applications from certain sources, etc. to using only an output portion of a display at interface component 206 and no other devices or portions of the display. Thus, applications executing via feature processor 204 can communicate content to the display via data communicating component 224, which can provide the data to UPM 202 for operating the display. Interface communicating component 212 provides the data to the display of interface component 206 based on the security profile related to the application executing on feature processor 204. Any other attempted access of interface component 206 by the application can be denied based on the security profile. This allows the application to provide visual content on the display without allowing further access to interface component 206 of the UPM 202.

In another specific example, security profiles 214 may indicate that applications from trusted sources are allowed access to an input portion of the display as well and/or to a card reader to process payment for certain items. In this example, the application can render data to the display of interface component 206 via feature processor 204 to UPM 202 communication and authorization as described. The application can also request to obtain input from the display, which interface access requesting component 222 can communicate to UPM 202 along with an identifier of the application, an indication of the source of the application, and/or an indication of whether the source is trusted. Access request receiving component 208 provides the request and/or related information to security analyzing component 210 to determine security policies related to the trusted source and/or the input portion of the display. Thus, in this example, access request receiving component 208 can grant the application access to the input portion of the touch screen display.

The application executing on feature processor 204 can then provide data for requesting input via data communicating component 224, which provides the data to UPM 202. This can be a prompt to display on the touch-screen display of interface component 206 (e.g., a prompt for an email address to sign up for a customer loyalty program at a related retail store). Interface communicating component 212 can cause the display to render the prompt and then provide any input back to the application via the feature processor 204 based on the security policy indicating that trusted sources can utilize the input portion of the touch-screen display.

In additional specific examples, security policies can allow for certain applications, types, sources, etc. to use a card reader, request certain types of data via the display, and/or the like. In one example, in this regard, the security policy can specify that certain input data from interface component 206 is to be encrypted when requested by a certain application, type, source, etc. (and/or an encryption algorithm, key, etc. for the interface component 206 (or interface communicating component 212) to use in encrypting the data). This requires the application to decrypt the data upon receipt, which can prevent data tampering when communicating between UPM 202 and feature processor 204.

In another example, in this regard, security profiles 214 can allow some applications, types, sources, etc. to use input components of interface component 206 along with some secure applications of UPM 202. For example, an application, type, source, etc. can be allowed to use not only the card reader of interface 206, but also the secure application that communicates with financial institutions to process related transactions. In this example, the application can request such use via interface access requesting component 222, as described, and can provide transaction information via data communicating component 224, such as a retail identifier related to the application, a transaction amount, an item purchased, etc. Thus, the application can present items on the display of interface component 206 for purchase, a user can select items for purchase. The application can provide transaction information to the payment application to process payment, and the interface communicating component 212, in one example, can refrain from allowing the application to access interface 206 while payment processing is performed. Once payment processing is complete, the interface communicating component 212 can allow the application to access the interface 206.

Moreover, this framework can allow for the UPM 202 and/or feature processor 204, or related applications, to provide abstraction layers or methods to isolate core legacy changes or other items that may affect the entire end to end business rule or rules, such as service oriented architecture (SOA). Thus, for example, feature processor 204 can execute applications intended to replace legacy applications of the UPM 202. Thus, where an application running on the feature processor 204 intended to replace a legacy application of UPM 202 fails (e.g., due to software upgrade), UPM 202 can invoke the legacy application to ensure the transaction is completed with little or no impact to merchant or customer. Examples of various services that may reside on, or at least be executed by, the feature processor 204 may include point-of-sale (POS) components, such as a card reader in dispenser (CRIND), components that provide business inventory reconciliation (BIR), transaction logging service (TLS), merchandising and discount service (MDS), code generation service (CGS), forecourt fuel dispensing server (FFDS), forecourt control service (FCS), tax systems, simple pumps or other fuel dispensing components, support application programming interfaces (API), CGS on enhanced dispenser hub (EDH), PaymentLoyaltyTokenConfiguration on EDH, etc. Additionally, these services may be located in the cloud as another form of abstraction.

Where UPM 202 is not present and/or feature processor 204 otherwise includes components of the UPM 202 and manages secure and non-secure applications, the components can function similarly as described above. In one example, the feature processor 204 may provide payment or other secure applications via an included interface component 206. Feature processor 204 can accordingly include an interface communicating component 212 for managing access of secured and non-secured applications to the interface component 206. Thus, where feature processor 204 is operating a payment application, in one example, interface communicating component 212 can prevent packets from non-secure applications from reaching the interface component 206. Secure and non-secure applications, and/or components to which the different types of applications have access, can be defined by security profiles 214 in a security analyzing component 210 implemented by feature processor 204. Moreover, in this regard, a dispenser that includes the feature processor 204 can become part of a SOA, described above and further herein.

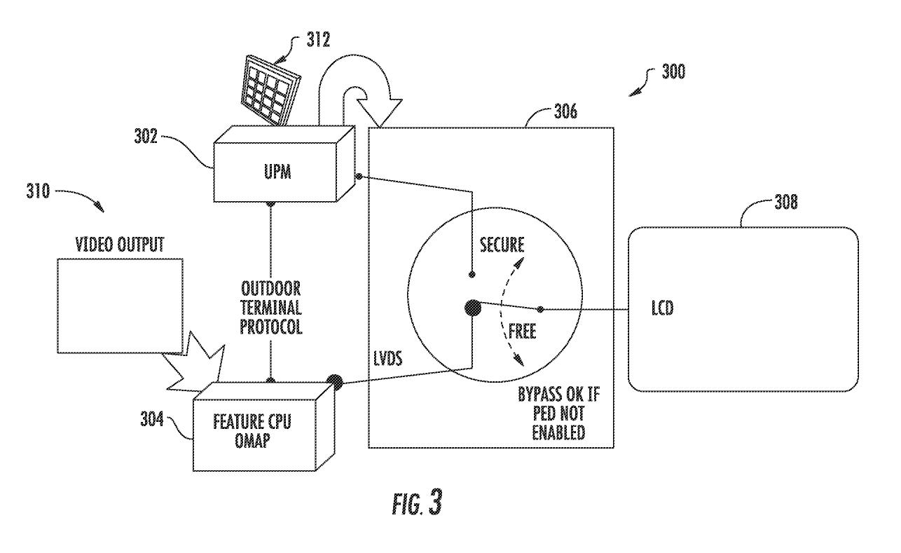

FIG. 3 illustrates an example system 300 for allowing a feature processor to display content on a display connected to a UPM. System 300 includes a UPM 302 and a feature central processing unit (CPU) open multimedia application platform (OMAP) 304 that can communicate using an outdoor terminal protocol. System 300 also includes a video switch 306, which can be part of the UPM 302, that allows for secure and non-secure (free) use of a liquid crystal display (LCD) 308 connected to the UPM 302.

According to an example, UPM 302 can operate the switch 306 to switch between UPM 302 and feature CPU OMAP 304 based on whether the UPM has activated one or more interface components. For example, UPM 302 can include a PIN entry device (PED) 312. When UPM 302 activates the PED 312 for PIN entry, it can switch the video switch 306 to facilitate secure communication with LCD 308. This closes otherwise possible communication paths between feature CPU OMAP 304 and the UPM 306 to prevent unauthorized access of the PED 312. When UPM 302 has not activated the PED or other interface devices, it can switch video switch 306 to allow non-secure applications to access LCD 308 via feature CPU OMAP 304. As shown, the feature CPU OMAP 304 can receive video output 310 for rendering to LCD 308 via UPM 302 when the video switch 306 so allows.

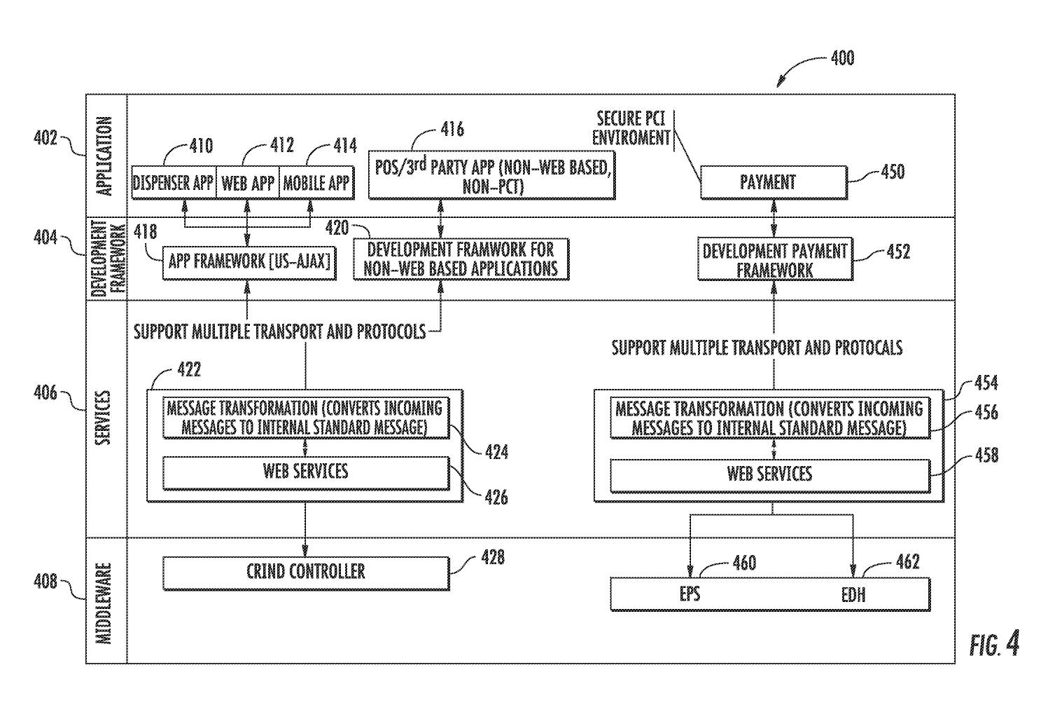

FIG. 4 illustrates an example SOA 400 related to applications executing on a feature processor and the master control configuration (e.g., SoM, UPM, etc.) at a fuel dispenser. The SOA depicts a feature processor application portion and a master control configuration portion. The SOA 400 includes various layers, including an application layer 402, a development framework 404, a services layer 406, and a middleware layer 408.

The application layer 402 includes a fuel dispenser application 410, web application 412, mobile application 414, and POS/third party applications 416 on the feature processor application portion, as applications accessible by or operating on the feature processor. The fuel dispenser application 410, web application 412, and mobile application 414 can communicate with an application framework 418, which can include JavaScript (JS), asynchronous JS and extensible markup language (XML) (AJAX), or similar components. The POS/third party applications 416 can communicate with a development framework for non-web based applications 420. Frameworks 418 and 420 can facilitate communicating with services 422 that include message transformation 424 and/or web services 426, for subsequently communicating with CRIND controller 428.

On the master controller configuration, the application layer 402 includes payment application 450, which communicates with a development payment framework 452. The development payment framework 452 facilitates communicating with services 454, which can include a message transformation 456 to convert incoming messages to an internal standard, and/or web services 458. Web services 458 can communicate with an EPS 460 or EDH 462 to facilitate communicating payment information for processing transaction payment, as described.

In the specific example shown, the master control configuration portion relates to a payment environment. In one example, if a new item introduced on the feature application portion (e.g., a software upgrade) results in an error due to the new implementation (software/hardware change for example), a default to the master control configuration portion may be invoked to ensure the transaction is completed with little or no impact to merchant or customer.

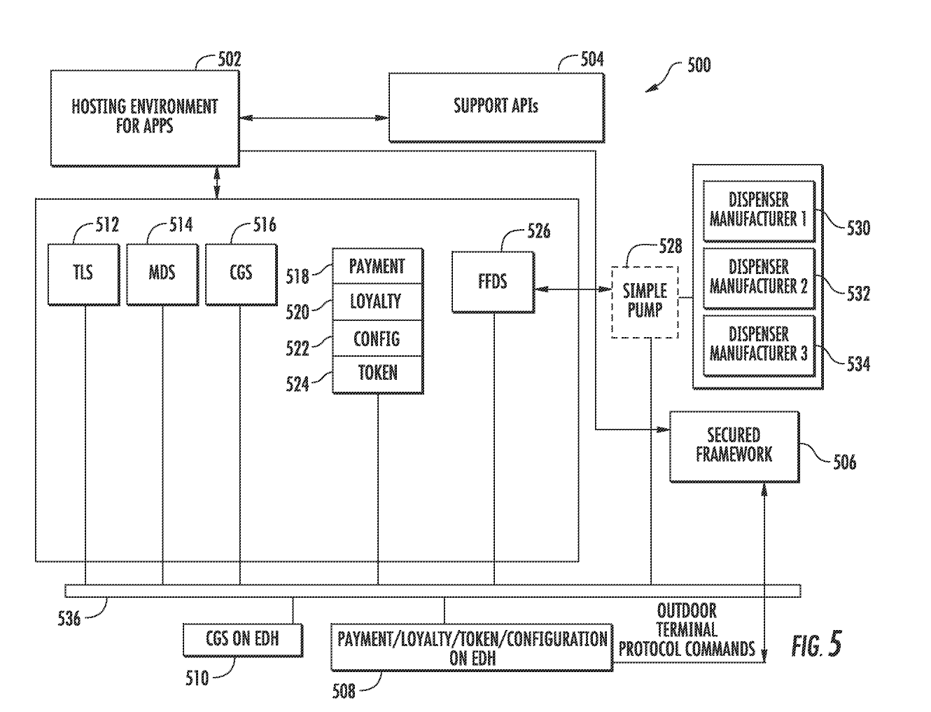

FIG. 5 illustrates an example fuel dispenser environment 500 in which various services can execute on a feature processor, as described herein. For example, one or more of a hosting environment for applications 502, support APIs 504, TLS 512, MDS 514, CGS 516, payment application 518, loyalty application 520, configuration application 522, token application 524, FFDS 526, etc. can operate on the feature processor. For example, FFDS 526 can facilitate communicating with a simple pump 528 and/or fuel dispensers (or related components) from dispenser manufacturer 1 530, dispenser manufacturer 2 532, and/or dispenser manufacturer 3 534. One or more of the components can communicate with secured framework 506 using one or more interfaces to access one or more secured components, such as a PED. In addition, one or more of the components can communicate with an EDH at 508 or 510 to facilitate processing transaction payment. The components can communicate over a backbone 536, as shown. The backbone 536 can be an architecture that facilitates communication among the devices, and can include a forecourt controller, a backroom, a local area network (LAN) switch or router, WiFi components, Bluetooth components, etc.

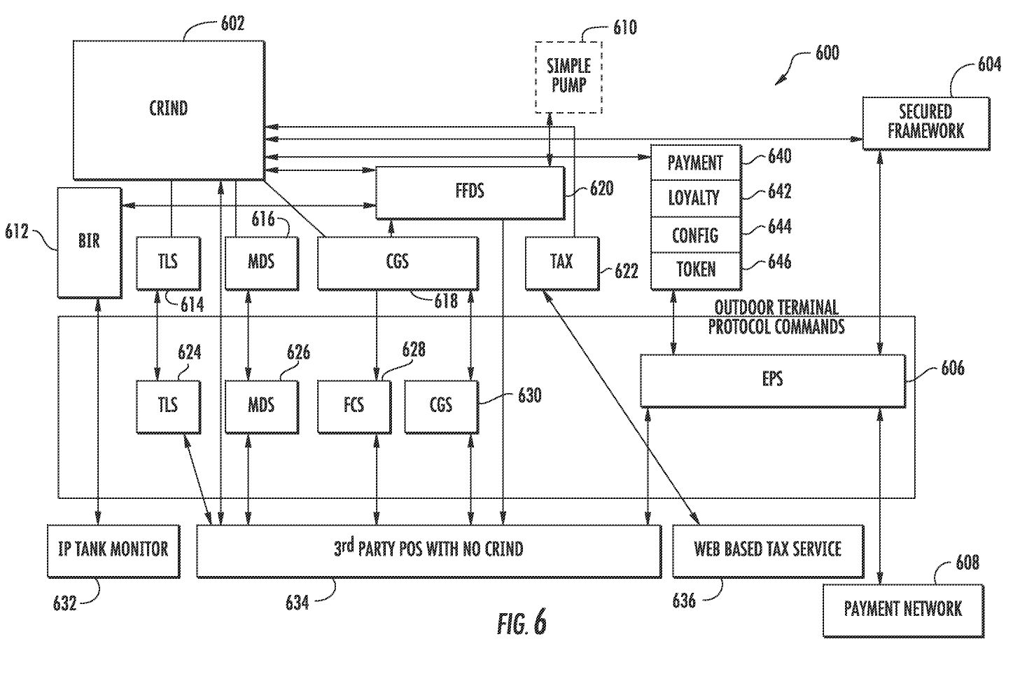

FIG. 6 illustrates an example fuel dispenser environment 600 in which various services can execute on a feature processor, as described herein. For example, one or more of a CRIND 602, BIR 612, TLS 614, MDS 616, CGS 618, FFDS 620, tax application 622, TLS 624, MDS 626, FCS 628, CGS 630, payment application 640, loyalty application 642, configuration application 644, token application 646, etc. can operate on the feature processor. For example, BIR can facilitate communicating with an IP tank monitor 632. FFDS 620 can facilitate communicating with a simple pump 610 and/or other fuel dispensing components. Tax application 622 can facilitate communicating with a web based tax service 636. TLS 624, MDS 626, FCS 628, CGS 630, etc. can facilitate communicating with a third party POS with no CRIND 634. In addition, for example, payment application 640, loyalty application 642, configuration application 644, and/or token application 646 can communicate with an EPS 606 to facilitate transaction payment processing (e.g., with payment network 608). One or more of the components can communicate with secured framework 604 using one or more interfaces to access one or more secured components, such as a PED.

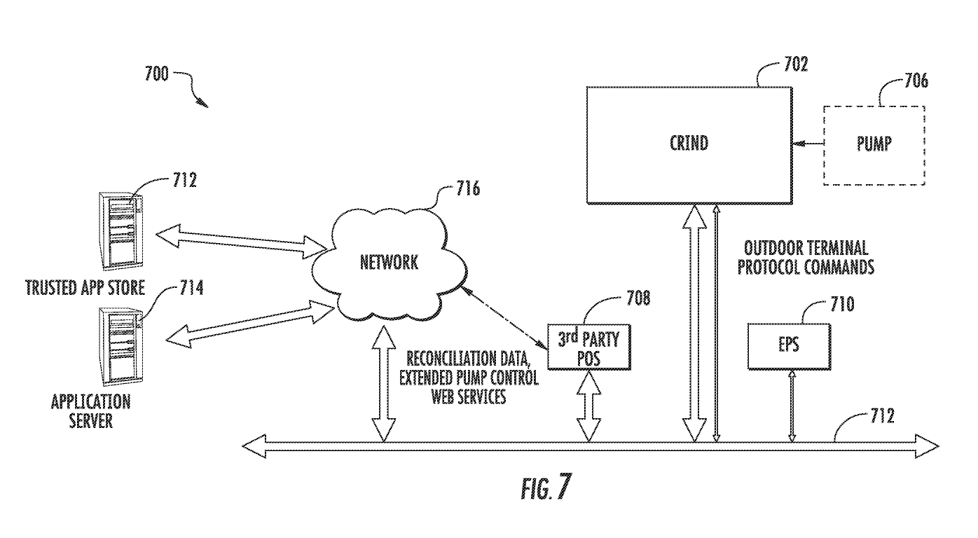

FIG. 7 illustrates an example system 700 for providing trusted applications for hosting by a fuel dispenser in accordance with aspects described herein. System 700 includes a CRIND application 702, which can execute on a SoM, and have an associated display. The CRIND application 702 can communicate with a pump 706 (or a fuel dispenser) and/or related components for processing transactions related thereto. CRIND application 702 can also communicate with a third party POS 708 and/or an EPS 710 over a backbone 718 to process payment for one or more transactions. System 700 also includes a trusted app store 712 and an application server 714 that can execute applications from the trusted app store 712. Backbone 718 also communicates over a network 716 that allows for communicating with the trusted app store 712 and/or application server 714. Network 716 can be the Internet, in one example.

According to an example, CRIND application 702 can be or can include a master control configuration, as described herein. As described, the CRIND application 702 can operate on a SoM, which can be the hardware configuration. In any case, CRIND application 702 can control access to display 704 according to aspects described herein (e.g., allowing access or varying levels of access for non-secure applications). In one example, CRIND application 702 can differentiate between applications from trusted app store 712 and other applications, as described, providing increased interface functionality to trusted applications. This can be based on security profiles defined in, or otherwise accessible by, CRIND application 702. For example, CRIND application 702 can provide trusted applications with full access to display 704, a card reader, a number pad, etc., while providing non-trusted applications with access to only an output portion of display 704 (e.g., so long as other interface components are not active). In other examples, as described, CRIND application 702 can restrict delivery of information from input devices to non-trusted sources (e.g., specific financial information is encrypted before delivering to the non-trusted source application).

In one example, trust of the application can be determined based on a source from where the application was downloaded (e.g., a trusted or non-trusted website). This information can be indicated in an application identifier in an access request, in one example, or otherwise determined by the CRIND application 702.

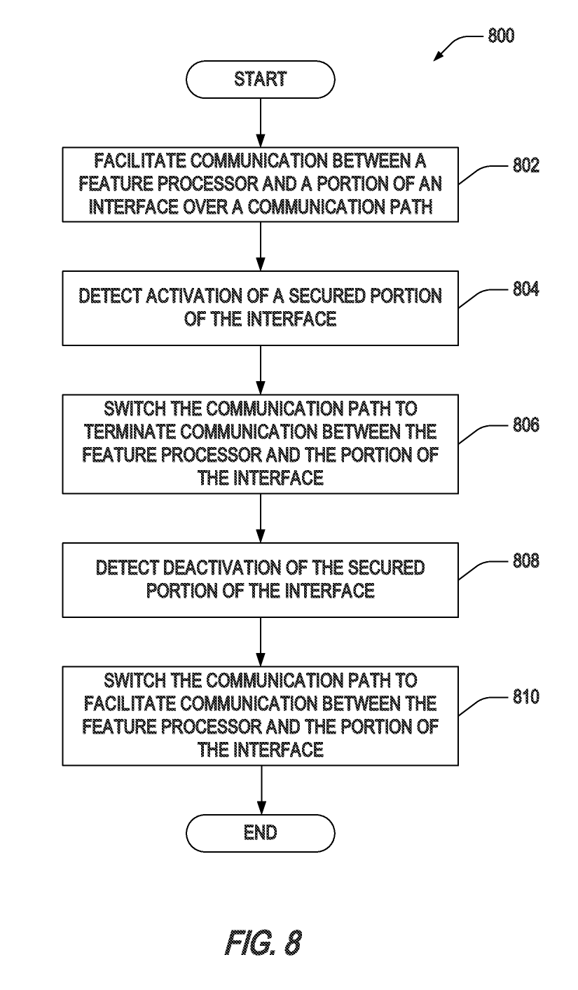

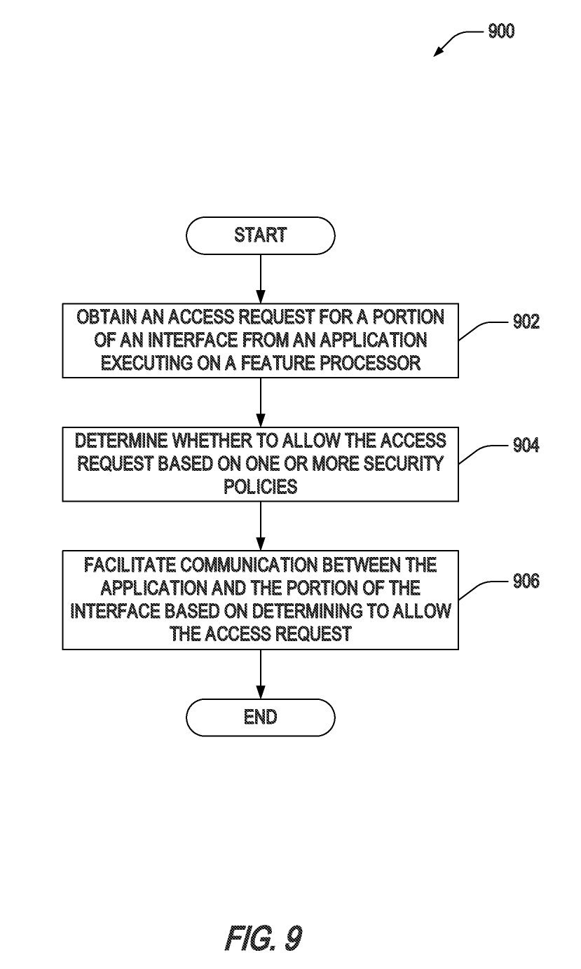

Referring to FIGS. 8 and 9, methodologies that can be utilized in accordance with various aspects described herein are illustrated. While, for purposes of simplicity of explanation, the methodologies are shown and described as a series of acts, it is to be understood and appreciated that the methodologies are not limited by the order of acts, as some acts can, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

FIG. 8 illustrates an example methodology 800 for allowing non-secured applications to access an interface in a secured framework. At 802, communication can be facilitated between a feature processor and a portion of an interface over a communication path. For example, the communication path can allow the feature processor, or an application executing thereon, to use at least a portion of an interface. In specific examples, this can include allowing the feature processor to stream video content to a display. It is to be appreciated that the portion of the interface to which access is allowed by the communication path can be limited by the hardware of the communication path, security policies implemented to route communications over the communications path, and/or the like.

At 804, activation of a secured portion of the interface can be detected. For example, this can include detecting activation of a number pad for entering a PIN, a request for confidential data on a touch-screen, etc., and the activation can be detected based on a generated event inside hardware hosting, or otherwise communicating with, the interface (e.g., a SoM, UPM, etc.).

At 806, the communication path can be switched to terminate communication between the feature processor and the portion of the interface. In this regard, any potential communication path for data from the interface to reach the feature processor can be eliminated. This can provide added security while the secured portion is activated. The switch can include a hardware switch between the communication path and an internal communication path, a determination by hardware hosting the interface to not allow data originating from the feature processor to reach the interface during the switching, etc.

At 808, deactivation of the secured portion of the interface can be detected. For example, the portion can be deactivated once requested interaction is complete (e.g., a PIN is received, an “OK” button is pressed, etc.). In addition, the deactivation can be detected based on a generated event or other indication.

At 810, the communication path can be switched to facilitate communication between the feature processor and the portion of the interface. Thus, because the secured portion of the interface is deactivated, the potential security risk is eliminated, and the feature processor can continue using the interface.

FIG. 9 illustrates an example methodology 900 for hosting applications in a secured framework. At 902, an access request for a portion of an interface can be obtained from an application executing on a feature processor. The access request can indicate the portion of the interface for which access is requested, an identifier of the application, a type of the application, a source of the application, etc., as described.

At 904, it can be determined whether to allow the access request based on one or more security policies. For example, the security policies can include a general policy for any application attempting to access certain portions of the interface, specific policies for specific applications, specific policies for application types, specific policies for application sources, and/or the like. Thus, for example, the determination at 904 can be based on locating a security policy related to the application based on the identifier, an identifier of the type of application, an identifier of the source of the application, etc. The security policy, in one example, can specify which portions of an interface can be access by the application, type, source, etc. (e.g., a display, an output portion of a display, etc).

At 906, communication between the application and the portion of the interface can be facilitated based on determining to allow the access request. As described, this can include switching hardware based on the security policies to allow communication, determining whether to route packets based on a destination and the security policies, etc. Moreover, at 904, the access request can be determined to be allowed or not based on whether another portion of the interface is active, as described above, and communications can be accordingly facilitated at 906.

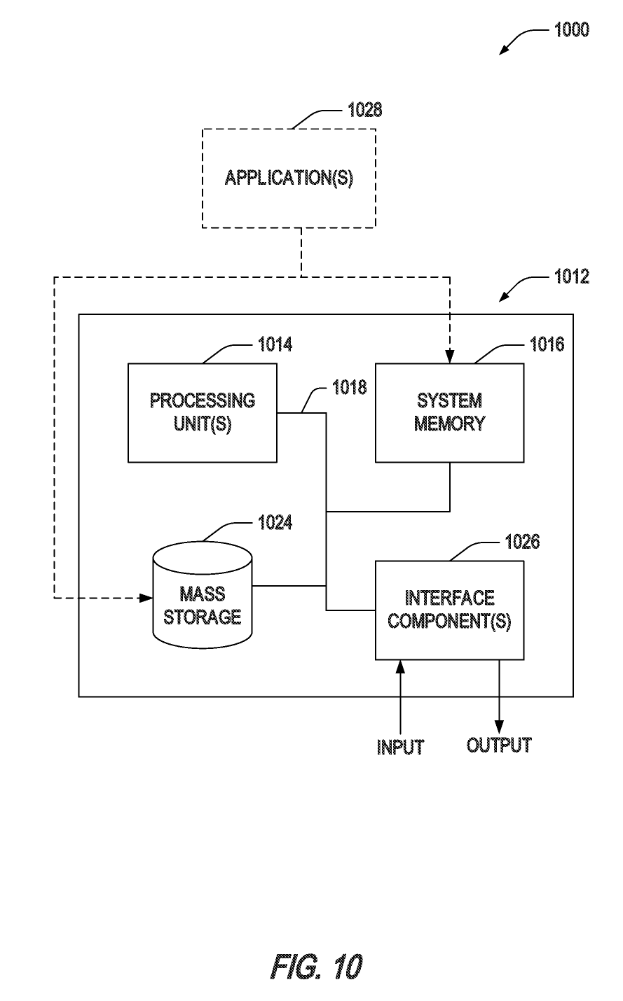

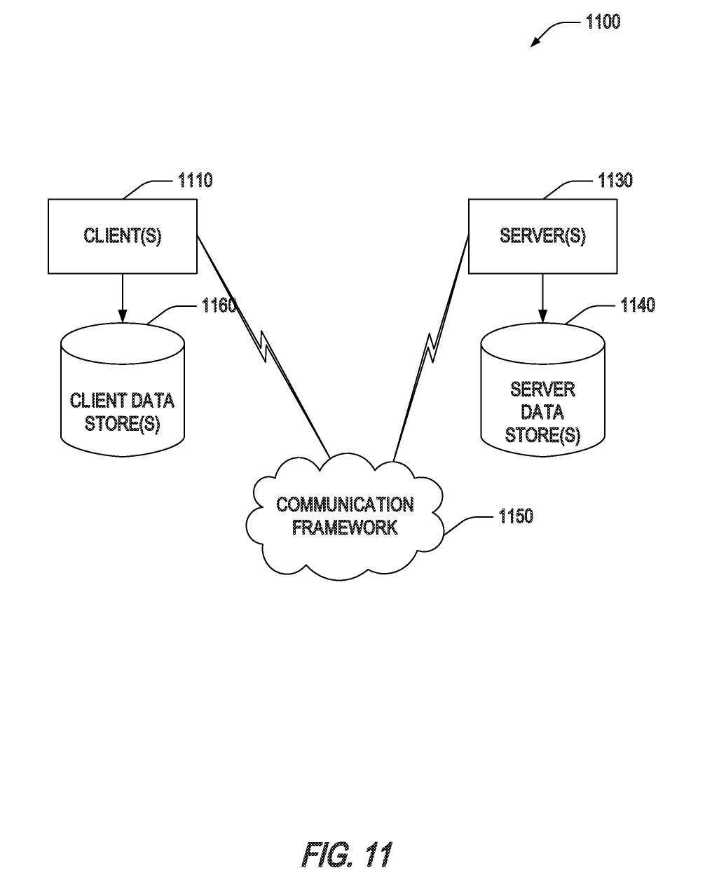

To provide a context for the various aspects of the disclosed subject matter, FIGS. 10 and 11 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 10, an exemplary environment 1000 for implementing various aspects disclosed herein includes a computer 1012 (e.g., desktop, laptop, server, hand held, programmable consumer or industrial electronics . . . ). The computer 1012 includes a processing unit 1014, a system memory 1016 and a system bus 1018. The system bus 1018 couples system components including, but not limited to, the system memory 1016 to the processing unit 1014. The processing unit 1014 can be any of various available microprocessors. It is to be appreciated that dual microprocessors, multi-core and other multiprocessor architectures can be employed as the processing unit 1014.

The system memory 1016 includes volatile and nonvolatile memory. The basic input/output system (BIOS), containing the basic routines to transfer information between elements within the computer 1012, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1012 also includes removable/non-removable, volatile/non-volatile computer storage media. FIG. 10 illustrates, for example, mass storage 1024. Mass storage 1024 includes, but is not limited to, devices like a magnetic or optical disk drive, floppy disk drive, flash memory or memory stick. In addition, mass storage 1024 can include storage media separately or in combination with other storage media.

FIG. 10 provides software application(s) 1028 that act as an intermediary between users and/or other computers and the basic computer resources described in suitable operating environment 1000. Such software application(s) 1028 include one or both of system and application software. System software can include an operating system, which can be stored on mass storage 1024, that acts to control and allocate resources of the computer system 1012. Application software takes advantage of the management of resources by system software through program modules and data stored on either or both of system memory 1016 and mass storage 1024.

The computer 1012 also includes one or more interface components 1026 that are communicatively coupled to the bus 1018 and facilitate interaction with the computer 1012. By way of example, the interface component 1026 can be a port (e.g., serial, parallel, PCMCIA, USB, FireWire . . . ) or an interface card (e.g., sound, video, network . . . ) or the like. The interface component 1026 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 1012 to output device(s) via interface component 1026. Output devices can include displays (e.g., cathode ray tube (CRT), liquid crystal display (LCD), light emitting diode (LCD), plasma . . . ), speakers, printers and other computers, among other things.

According to an example, the processing unit(s) 1014 can comprise or receive instructions related to controlling access of certain application, types, sources, etc. to interface component(s) 1026, which can be similar to interface 104, interface component 206, etc., and/or other aspects described herein. It is to be appreciated that the system memory 1016 can additionally or alternatively house such instructions and the processing unit(s) 1014 can be utilized to process the instructions. Moreover, the system memory 1016 can retain and/or the processing unit(s) 1014 can comprise instructions to effectuate updating of the directory objects to ensure replication with one or more additional operating environments, for example. System 1000, or at least computer 1012, can include a SoM, a UPM, etc., as described.

FIG. 11 is a schematic block diagram of a sample-computing environment 1100 with which the subject innovation can interact. The environment 1100 includes one or more client(s) 1110. The client(s) 1110 can be hardware and/or software (e.g., threads, processes, computing devices). The environment 1100 also includes one or more server(s) 1130. Thus, environment 1100 can correspond to a two-tier client server model or a multi-tier model (e.g., client, middle tier server, data server), amongst other models. The server(s) 1130 can also be hardware and/or software (e.g., threads, processes, computing devices). The servers 1130 can house threads to perform transformations by employing the aspects of the subject innovation, for example. One possible communication between a client 1110 and a server 1130 may be in the form of a data packet transmitted between two or more computer processes.

The environment 1100 includes a communication framework 1150 that can be employed to facilitate communications between the client(s) 1110 and the server(s) 1130. Here, the client(s) 1110 can correspond to program application components and the server(s) 1130 can provide the functionality of the interface and optionally the storage system, as previously described. The client(s) 1110 are operatively connected to one or more client data store(s) 1160 that can be employed to store information local to the client(s) 1110. Similarly, the server(s) 1130 are operatively connected to one or more server data store(s) 1140 that can be employed to store information local to the servers 1130.

By way of example, one or more clients 1110 can be a trusted application requesting access to an interface at the server(s) 1130 via communication framework 1150. The server(s) 1130, in this regard, can be at, or can access, a fuel dispenser. The server(s) 1130 can, in one example, obtain input for the trusted application where so allowed by security policy, and transmit such back to the client(s) 1110 via communication framework 1150. The client(s) 1110, in one example, can store the input in the client data store(s) 1160, for example, or otherwise process the input.

The various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above. An exemplary storage medium may be coupled to the processor, such that the processor can read information from, and write information to, the storage medium. In the alternative, the storage medium may be integral to the processor. Further, in some aspects, the processor and the storage medium may reside in an ASIC.

In one or more aspects, the functions, methods, or algorithms described may be implemented in hardware, software, firmware, or any combination thereof. If implemented in software, the functions may be stored or transmitted as one or more instructions or code on a computer-readable medium, which may be incorporated into a computer program product. Computer-readable media includes both computer storage media and communication media including any medium that facilitates transfer of a computer program from one place to another. A storage medium may be any available media that can be accessed by a computer. By way of example, and not limitation, such computer-readable media can comprise random access memory (RAM), read-only memory (ROM), electrically erasable programmable ROM (EEPROM), compact disc (CD)-ROM or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While one or more aspects have been described above, it should be understood that any and all equivalent realizations of the presented aspects are included within the scope and spirit thereof. The aspects depicted are presented by way of example only and are not intended as limitations upon the various aspects that can be implemented in view of the descriptions. Thus, it should be understood by those of ordinary skill in this art that the presented subject matter is not limited to these aspects since modifications can be made. Therefore, it is contemplated that any and all such embodiments are included in the presented subject matter as may fall within the scope and spirit thereof.

What is claimed is:

1. A master control apparatus for hosting applications at a fuel dispenser, comprising:
an interface component for providing input to or output from the master control apparatus; and
an interface communicating component for establishing a communications path to a non-secured portion of the interface component when a secured portion of the interface component is active,
wherein the interface communicating component provides data from a feature apparatus to the non-secured portion of the interface component over the communications path, and switches the communications path to refrain from providing data from the feature apparatus to the non-secured portion of the interface component where the secured portion of the interface component is active.

2. The master control apparatus of claim 1, wherein the non-secured portion of the interface component is a video display, and the data is video or pictorial data to be rendered on the video display.

3. The master control apparatus of claim 1, wherein the interface communicating component further switches the communications path to provide data from the feature apparatus to the non-secured portion of the interface where the secured portion of the interface component is inactive.

4. The master control apparatus of claim 1, wherein the switching the communications path comprises disabling a feature connector to which the feature apparatus is coupled.

5. The master control apparatus of claim 1, wherein the secured portion comprises a universal payment module.

6. A method for providing security for a secured portion of a fuel dispenser, comprising:
providing input to or output from a master control apparatus;
establishing a communications path from the master control apparatus to a non-secured portion of the fuel dispenser when the secured portion of the fuel dispenser is active;
providing data from a feature apparatus to the non-secured portion of the fuel dispenser over the communications path; and
switching the communications path to refrain from providing the data from the feature apparatus to the non-secured portion of the fuel dispenser where the secured portion of the fuel dispenser is active.

7. The method of claim 6, further comprising rendering video or pictorial data on a video display, wherein the non-secured portion of the fuel dispenser comprises the video display.

8. The method of claim 6, further comprising switching the communications path to provide data from the feature apparatus to the non-secured portion of the fuel dispenser where the secured portion of the fuel dispenser is inactive.

9. The method of claim 6, wherein the switching the communications path comprises disabling a feature connector to which the feature apparatus is coupled.

10. The method of claim 6, wherein the secured portion comprises a universal payment module.

11. A master control apparatus for hosting applications at a fuel dispenser, comprising:
an interface component for providing input to or output from the master control apparatus;
an access request receiving component for obtaining an access request for a portion of the interface component from an application executing on a feature processor;
a security analyzing component for determining whether to allow the access request based on one or more security policies; and
an interface communicating component for facilitating communication between the application and the portion of the interface component where the security analyzing component determines to allow the access request.

12. The master control apparatus of claim 11, wherein the interface communicating component modifies at least a portion of data communicated between the application and the portion of the interface component based on the one or more security policies.

13. The master control apparatus of claim 11, wherein the one or more security policies relate to the application or the portion of the interface component.

14. The master control apparatus of claim 11, wherein the one or more security policies relate to a type of the application or a source of the application.

15. The master control apparatus of claim 11, wherein the interface communicating component terminates communication between the application and the portion of the interface component based at least in part on detecting activation of a secured portion of the interface component to which the application does not have access according to the one or more security policies.

16. The master control apparatus of claim 15, wherein the terminating the communication comprises disabling a feature connector through which the feature processor communicates with the master control apparatus.

17. The master control apparatus of claim 11, wherein the interface component comprises a video display, and the access request relates to using a touch-screen functionality of the display.

18. A method for hosting applications in conjunction with a secured framework at a fuel dispenser, comprising:
providing input to or output from a master control apparatus that controls access to one or more components of the fuel dispenser;
obtaining an access request for a portion of the one or more components from an application executing on a feature processor;
determining whether to allow the access request based on one or more security policies; and
facilitating communication between the application and the one or more components of the fuel dispenser based at least in part on determining whether to allow the access request.

19. The method of claim 18, further comprising modifying at least a portion of data communicated between the application and the one or more components based on the one or more security policies.

20. The method of claim 18, wherein the one or more security policies relate to the application or the one or more components.

21. The method of claim 18, wherein the one or more security policies relate to a type of the application or a source of the application.

22. The method of claim 18, further comprising terminating communication between the application and the one or more components based at least in part on detecting activation of a secured portion of the fuel dispenser to which the application does not have access according to the one or more security policies.

23. The method of claim 22, wherein the terminating communication comprises disabling a feature connector through which the feature processor communicates with the master control apparatus.

24. The method of claim 18, wherein the one or more components comprises a video display, and the access request relates to using a touch-screen functionality of the display.
